(19) United States
(12) Patent Application Publication
(10) Pub. No.: US 2012/0049760 A1
(43) Pub. Date: Mar. 1, 2012

(54) APPARATUS AND METHODS FOR DIMMING ILLUMINATION DEVICES

(75) Inventors: Greg Dennis, Justin, TX (US); Reju Rajan, Grand Prairie, TX (US)

(73) Assignee: CONTROL PRODUCTS CORPORATION, Grand Prairie, TX (US)

(21) Appl. No.: 12/872,063

(22) Filed: Aug. 31, 2010

(51) Int. Cl. H05B 37/02

(52) U.S. Cl. 315/294

(57) ABSTRACT

A method of dimming a plurality of LEDs includes generating a first pulse-width modulated (PWM) waveform and generating a plurality of second PWM waveforms, each of the PWM waveforms having a duty cycle. The duty cycle of the first PWM waveform and the duty cycle of each of the second PWM waveforms begin at approximately the same time. The periods of each of the second PWM waveforms end before the end of the first PWM duty cycle. In the method, and in disclosed circuits and devices, a first switch is closed in response to the duty cycle of the first PWM waveform, and each of a plurality of second switches connected between the first switch and a corresponding plurality of LEDs is closed in response to the respective duty cycles of each second PWM waveform, so that each LED connected between each second switch and a power source is energized when the first switch and the corresponding second switch are closed and not energized when either the first switch or the corresponding second switch is open. In this way, the chromaticity of each LED is not affected by the length of the duty cycle of the dimming PWM.

### BACKGROUND

1. Technical Field

This Application relates to control of both the brightness and color quality of illumination devices, in particular, light-emitting diodes (LEDs).

2. Background

As used in this disclosure, “light-emitting diode” or “LED” means any electroluminescent diode or other type of carrier injection or junction-base device that is capable of receiving an electrical signal and producing radiation in response to the signal. Thus, these terms include light-emitting diodes of all types, light-emitting polymers, semiconductor dies that produce light in response to current, organic LEDs, electro-luminescent films, laser diodes, and other such systems. In some embodiments, the terms may refer to a single light-emitting diode having multiple semiconductor dies that are individually controlled. Light from LEDs of different colors (e.g., red, green, and blue) has been used to create a light source of predetermined spectral balance, for example a white light source.

The term “color” refers to any frequency or combination of frequencies of radiation within a spectrum; that is, a “color,” as used in this application, should be understood to encompass not only frequencies of the visible spectrum, but also frequencies in the infrared and ultraviolet areas of the spectrum, and in other areas of the electromagnetic spectrum.

The term “pulse-width modulation” or “PWM” refers to modulation of a digital signal that has a repeating constant time interval, or period, where within each period a portion of the signal is high (digital 1) and the remaining portion of the signal is low (digital 0). Pulse-width modulation is accomplished by varying the widths of the respective high and low portions of the signal within the period. In this application, PWM may also refer to a circuit implementing pulse-width modulation.

The term “duty cycle” refers to that portion of the period of a PWM during which the signal allows current to flow through a circuit responsive to the PWM signal. The duty cycle may be active high or active low, depending on the requirements of the circuit layout.

The term “off time” refers to that portion of the period of a PWM during which the signal is preventing current to flow through the circuit. This signal will have an opposite digital value than the duty cycle. It is important to note that the sum of the duty cycle and the off time should equal the period.

The term “iteration” refers to the shortest non-zero duty cycle that a given PWM can implement. The period, duty cycle, and off time of a PWM would not contain any incomplete iterations. That is, the period, duty cycle and off time of a PWM are each integral multiples of the time required to complete one iteration.

The term “chromaticity” refers to any specific color as defined by a CIE color system, such as CIE1931 or CIE 1976, or similar. The CIE system is well known to those skilled in the art.

For a combined light source, a great many colors can be produced by choosing a particular set of intensities for the several colored sources making up the combined source. It is common practice, in an eight-bit system for example, to set the brightness of each LED in the combined source at one of 2⁸, or 256, different levels. In general, there is a possible color space of 256ⁿ colors, where n represents the number of sources present in the system. Changing the current supply to an LED will directly control the brightness of the lamp, but for most LEDs, a change in current will also change the chromaticity of the lamp. It is known to use a pulse-width modulated waveform to drive LEDs, thus allowing dimming of an LED without color shift, since the resulting brightness depends on the duty cycle of the driving pulse, not on its amplitude. That is, the current through the LED is constant during the duty cycle, and the off time is not detected because of human persistence of vision. At present, however, it has not been possible to change the brightness of a light source made from combined colored LEDs without changing the combined chromaticity of the light produced.

To dim a combined light source properly while maintaining a given chromaticity, it is preferable to proportionally scale the duty cycles of each component color. A problem arises, however, because PWM duty cycles must be considered integers, and cannot be scaled accurately when the fractional scaled value is truncated and the fractional portion is removed. More specifically, scaling an n-bit color space (2ⁿ colors) to half brightness yields a (n−1)-bit color space (2ⁿ⁻¹ colors). For example, a typical red-green-blue (RGB) value of 250/128/74 can be scaled to half brightness by using an RGB value of 125/64/37, but cannot be scaled to one-quarter brightness because the resulting RGB value (64/32/18) is not proportional to the original value, yielding a slightly different chromaticity. As the brightness continually reduces, the color shift is more and more significant and can yield undesirable results.

It is, therefore, advantageous to control both the luminous intensity (brightness) of such a combined light source and the chromaticity, or color quality, of the light source independently. Maintaining chromaticity can be particularly important for white light sources, where any color change can be undesirable. A solution is needed that will separate the control of luminosity of the combined lamp from control of the color quality.

### DRAWINGS

FIG. 1 is a block diagram of an exemplary circuit for controlling the intensity of a combined LED light source without changing its chromaticity.

FIG. 2 is a timing diagram for embodiment having three colored LEDs.

FIG. 3 is an exemplary circuit diagram for one embodiment of a method for controlling the intensity of a combined LED light source without changing its color quality.

FIG. 4 is a schematic depiction of an application of the disclosed method and apparatus used with an instrument panel and with an area lighting system.

### DESCRIPTION

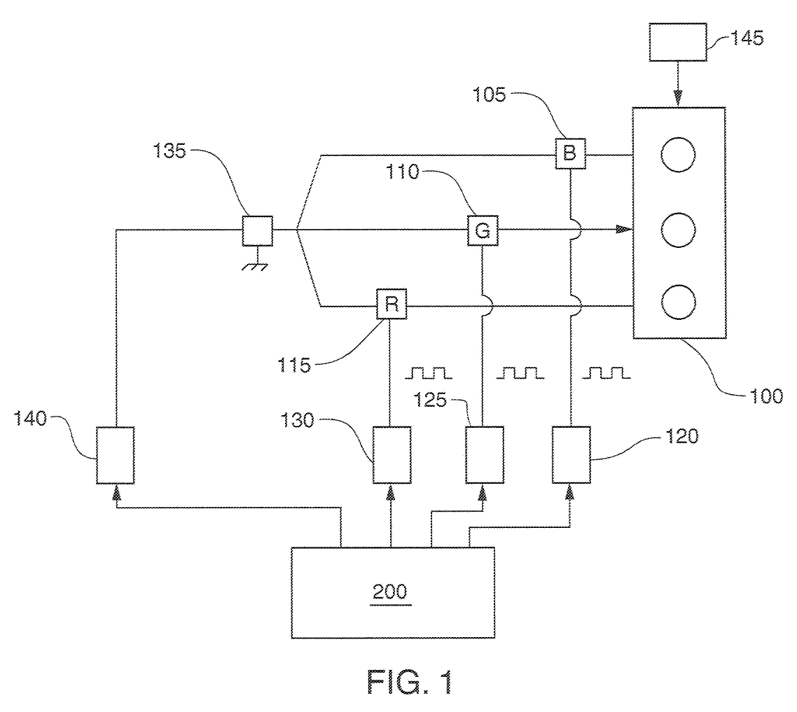

FIG. 1 is an exemplary block diagram of one embodiment. Current to a lamp module (100) comprising red, green and blue LEDs is selectively applied to each LED through a corresponding red switch (105), green switch (110) and blue switch (115). A suitable lamp module is readily available through any major LED manufacturer or their distributors. The term “switch” is here used in its most general sense, to refer not only to mechanical switches or relays, but any means for selectively interrupting the flow of current in an electrical circuit. Typical switches for the present application would be junction transistors or field-effect transistors. The reader should also note that a “switch” in this application need not be a discrete circuit component, but may be integrated into another circuit, such as a microprocessor.

Each of the red switch (105), green switch (110) and blue switch (115) is controlled by a corresponding source of pulse-width modulated waveforms, here referred to as a red PWM source (120), green PWM source (125) and blue PWM source (130).

The terminals of the red switch (105), green switch (110) and blue switch (115) not coupled to the LEDs are commonly connected to a dimmer switch (135), so that when the dimmer switch (135) is closed, the LEDs comprising the lamp module (100) are energized according to the state of the red switch (105), green switch (110) and blue switch (115), as controlled by their respective PWM sources (120, 125, 130). The dimmer switch (135) is controlled by a dimmer PWM source (140). A power source (145) is coupled to the lamp module (100), and the circuit as shown is presumed to find its return through the dimmer PWM switch (135).

The waveforms of the red, green and blue PWM sources (120, 125, 130) and the waveform of the dimmer PWM source (140) are synchronized so that the iterations of each of the respective PWM sources (120, 125, 130, 140) begin at substantially the same time. The duty cycle of the dimmer PWM source (140) preferably contains an integral multiple of the each of the periods of the red, green, and blue PWM sources (120, 125, 130).

The reader should understand that FIG. 1 is only an illustration of the general principle, and that in other embodiments, the dimmer switch (135) may be located between the lamp module (100) and the power supply (140), the layout assumed in the circuit may be reversed, or there may be more or fewer LEDs of different colors (not necessarily red, green and blue) comprising the lamp module (100). Also, the dimmer PWM source (140) and individual color PWM sources (120, 125, 130) may be controlled within the same device such as an integrated-circuit processor, which may allow the elimination of the dimmer switch (135) if its function is maintained within the control logic. This embodiment is discussed below.

In one embodiment, a programmed processor produces the waveforms of the various PWM sources. In this disclosure, a “processor” refers to any method or system for processing in response to a signal or data and should be understood to encompass microprocessors, integrated circuits, computer software, computer hardware, electrical circuits, application-specific integrated circuits, personal computers, chips, and other devices capable of providing processing functions. The application of a processor in various embodiments is discussed in more detail below. FIG. 1 shows a processor (200) controlling the operation of the various switches.

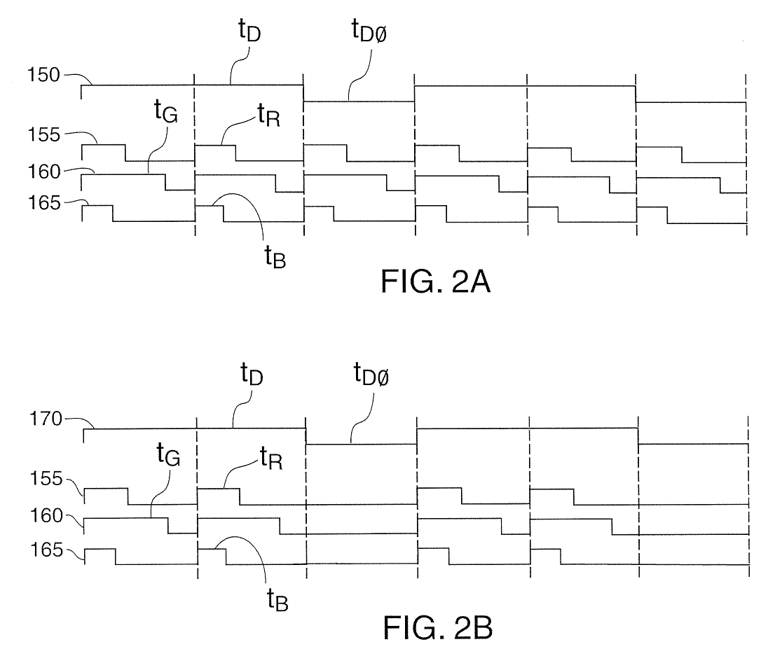

FIG. 2 shows exemplary timing diagrams of various PWM waveforms relevant to the control of color and intensity of a lamp module (100). FIG. 2 shows two periods of the switching waveform (150) from the dimming PWM source (140), each period of the dimmer switching waveform (150) comprising three iterations; and six periods of the switching waveforms (155, 160, 165) for the respective red switch (105), green switch (110) and blue switch (115), each period comprising three iterations. Again, there may be more or fewer LEDs of different colors (and not necessarily red, green and blue) comprising the lamp module (100).

In the example of FIG. 2A, the color switching waveforms (155, 160, 165) have predetermined duty cycles to achieve the desired resultant combined color from the several LEDs. Each synchronized period of these color PWM signals (155, 160, 165) is referred to here collectively as a “color cycle”. Beginning at the left of FIG. 2A, the timing diagram shows a sequence of color cycles, where duty cycles have a duration of t_{R}, t_{B}, and t_{G} for the three colors, respectively. The dimming waveform (150) has a duty cycle t_{D}, such that the entire color cycle equals at most a single iteration of the dimming waveform. In this example, the dimming duty cycle, t_{D}, accommodates two color cycles of each of the color waveforms (155, 160, 165), with the dimming off time accommodating a single color cycle. In other embodiments, however, more or fewer complete color cycles might be accommodated within t_{D} to achieve desired resultant brightness.

The duty cycle of the PWM waveforms shown in FIGS. 2A and 2B is assumed to be high, but in other embodiments, the duty cycle could be the state where the PWM waveforms are low, depending on the configuration of the switches and what manner of signal closes them.

The circuit and method disclosed can thus be understood as nested PWM sources where the “outer” PWM controls dimming and the two or more “inner” PWM sources control color. Each iteration of the dimming waveform (150) contains at least one full color cycle, preferably exactly one. The reader can see from FIGS. 1 and 2 that when the dimming duty cycle T_{D} ends, the circuit cuts power to the lamp module (100) while still allowing the color cycles to run. Continuously running the color PWM sources (120, 105, 115) during the dimming cycle (150) off time is not required, but it is simpler to implement in a processor, and helps to maintain proper timing.

In another embodiment, however, shown in FIG. 2B, the dimming control function of the dimming PWM waveform (150) could be implemented in a programmed processor (200) by turning off the color cycles during the time that would otherwise be the dimming PWM off time. This would eliminate the need for a dimming switch (135). In this embodiment, a pre-determined periodic time interval (170) is established, corresponding to the claimed “first duty cycle” for controlling a dimming switch (135). The programmed processor (200) detects the end of the periodic time interval (170) by means known in the art, such as generation of an interrupt when a counter reaches a zero value. The switching waveforms of the red, green and blue PWM sources (120, 125, 130) and the waveform of the periodic time interval (170) are synchronized so that the iterations of each begin at substantially the same time. In this embodiment, the processor (200) is programmed to turn off the color switching waveforms (150, 155, 165) when the periodic time interval (170) has elapsed, and turn the color switching waveforms (150, 155, 165) on again when the programmed processor (200) restarts the periodic time interval (170).

In general, the dimming PWM waveform should have a frequency (periods per second), greater than the refresh rate of the human eye to eliminate a flickering appearance. Typically frequencies of 60 Hz or greater are sufficient, while higher frequencies will produce a more even appearance.

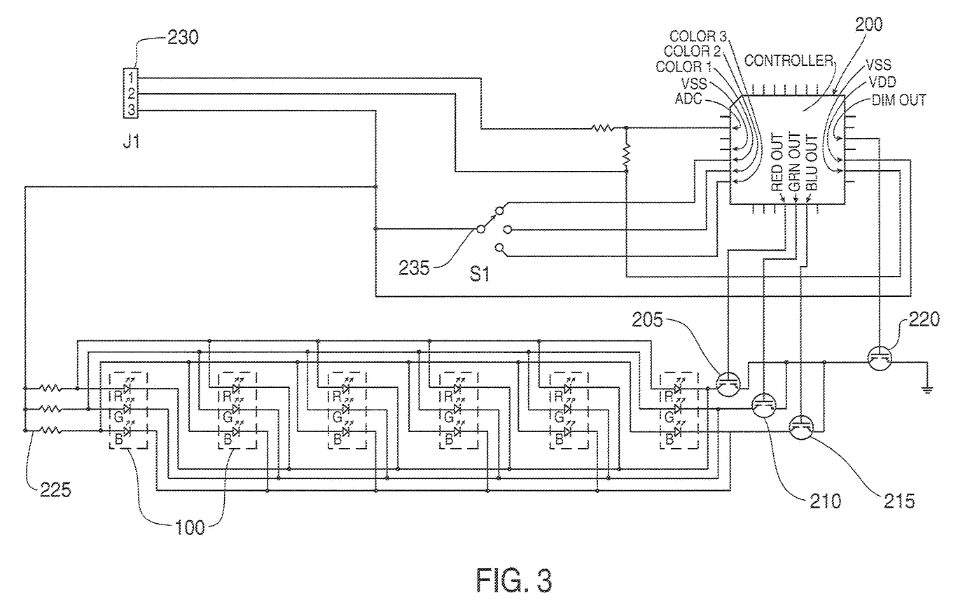

FIG. 3 is an exemplary circuit diagram for implementing an embodiment having four lamp modules. In FIG. 3, a programmable processor (200) generates the various PWM waveforms. A suitable processor is the PIC PIC18F24K20 programmable integrated circuit, or PIC chip, manufactured by Microchip Technology, Inc. of Chandler, Ariz. The teachings of the PIC18(L)F2X/4XK22 Data Sheet, Microchip Technology, Inc., 2010 are incorporated herein by reference. Any means capable of controlling the PWM sources and the lamp modules of this disclosure may be used. For example, an application specific integrated circuit (ASIC) may be used instead of the processor (200), or other commercially available processors may also be adapted for use by those skilled in the art.

The outputs of the PIC processor as shown in FIG. 3 selectively switch transistors that control current through the lamp modules (100). As shown, two transistors in integrated circuit U3 (205) control the current for the red and green LEDs in the lamp modules (100), and a transistor in integrated circuit U2 (210) controls the current for the blue LEDs in the lamp modules. Transistor arrays U2 and U3 are coupled to transistor array U1 (215), which is switched by the dimming waveform from the processor (200). Resistors (225) are chosen to adjust the current through the respective red, green and blue LEDs of the lamp modules (100) to achieve the desired maximum brightness. A switch (235) in this example (not required) conveniently allows selection of three pre-defined colors.

The following table shows a pseudocode implementation of one method of dimming a lamp module according to the present disclosure, where an 8-bit processor is used:

| Variable | Use | Values |
|---|---|---|
| tick_dimmer | counter for dimming loop | 0 . . . ? |
| | period [or duty cycle?] | |
| dimmerPulse | dimmer duty cycle width | 0 . . . tick_dimmer |
| tick_color | counter for color loop period | 0 . . . 255 (for 8-bit system) |
| redPulse | red pulse width | 0 . . . tick_color |
| greenPulse | green pulse width | 0 . . . tick_color |
| bluePulse | blue pulse width | 0 . . . tick_color |

Implementation:
main loop

0 −> tick_dimmer
if tick_dimmer ≠ dimmerPulse, then enable power to all components
do while tick_dimmer ≠ [count timing dimmer PWM duty cycle]

0 −> tick_color
if tick_color ≠ redPulse , then enable power to red component
if tick_color ≠ greenPulse, then enable power to green
component
if tick_color ≠ bluePulse then enable power to blue component
do while tick_color ≠ 255

increment tick_color
if tick_color = redPulse, disable power to red component
if tick_color = greenPulse, disable power to green
component
if tick_color = bluePulse, disable power to blue component

end while // if tick_color = 255
increment tick_dimmer
if tick_dimmer = dimmerPulse, disable power to all components

end while // if tick_dimmer = [ count timing dimmer PWM duty
cycle]

restart main loop

Those skilled in the art of programming microprocessors can easily implement the pseudocode routines above in the assembly language of a particular processor, or in a compiled language for such a particular processor.

The values for the dimmerPulse and color pulse-width variables shown above can set by external routines or hard-coded into the program. In some versions, for example, dimming could be implemented by an analog signal input to an analog-to-digital converter (ADC) present on or input to the processor (200). The output of the ADC could be used to derive the value for the dimmerPulse variable. In practice, the pulse widths of any of the PWMs could be tied to an ADC in this way.

The reader will see that because the tick_color loop is nested within the tick_dimmer loop, exactly one full color cycle will complete for every iteration of the tick_dimmer loop. Further, the beginning and end of the color cycle will automatically synchronize with the change of state of the dimming waveform, thus preventing any mid-color-cycle cutoff, which would also result in an undesirable color shift.

Many microprocessors, such as the exemplary PIC18F24K20 referred to above, have several internal timers, which can be set to generate an interrupt when a register overflows (e.g., when a certain count is reached), and thus aid proper timing.

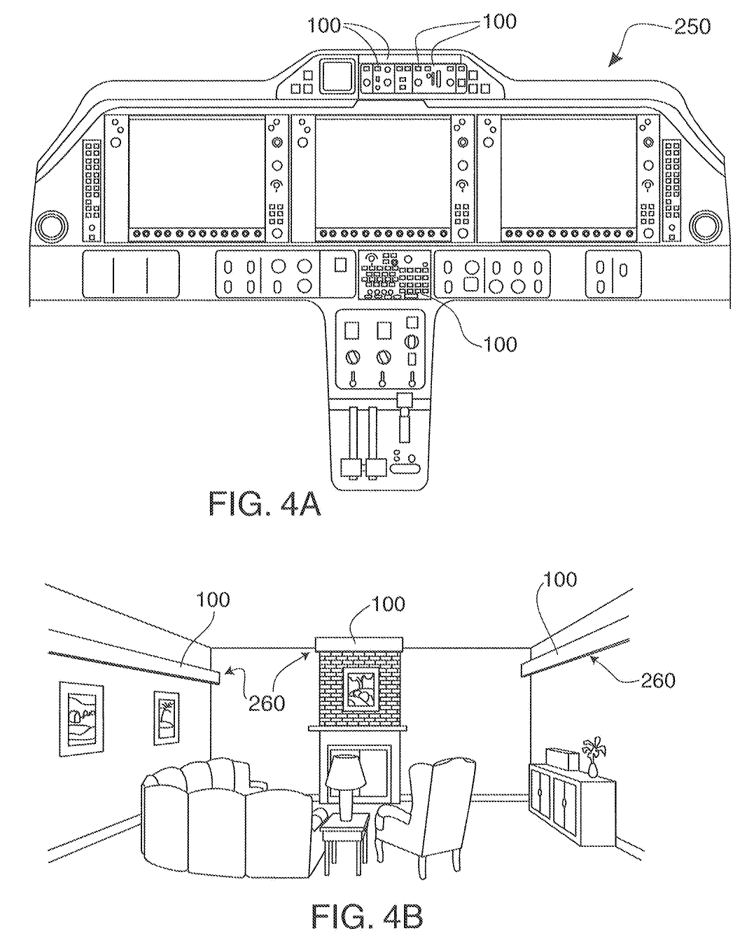

FIG. 4 shows exemplary applications of the disclosed method and apparatus. FIG. 4A shows an application where lighting for an instrument panel is controlled. The instrument panel (250) may be, for example, part of an aircraft, a motor vehicle, a vessel, appliance, or an industrial machine. Such instrument panels (250) may require selective dimming of both white and colored lights. For example, the standard NVIS green lighting for instrument panels used with night-vision aids can be dimmed without a change in chromaticity. FIG. 4B shows an application for an area lighting system (260), which could be cabin or cockpit lighting, or area lighting for a home or office, or an outdoor area.

None of the description in this application should be read as implying that any particular element, step, or function is an essential element that must be included in the claim scope; the scope of patented subject matter is defined only by the allowed claims. Moreover, none of these claims are intended to invoke paragraph six of 35 U.S.C. Section 112 unless the exact words “means for” are used, followed by a gerund. The claims as filed are intended to be as comprehensive as possible, and no subject matter is intentionally relinquished, dedicated, or abandoned.

We claim:

1. A method of dimming a plurality of LEDs, comprising:
generating a first pulse-width modulated (PWM) waveform;
the first PWM waveform having a first duty cycle
generating a plurality of second PWM waveforms;
each of the plurality of second PWM waveforms having a duty cycle;
starting the duty cycle of the first PWM waveform and the duty cycle of each of the second PWM waveforms at approximately the same time;
ending the periods of each of the second PWM waveforms before the end of the first PWM iteration;
closing and opening a first switch in response to the duty cycle of the first PWM waveform;
closing and opening each of a plurality of second switches connected between the first switch and a corresponding plurality of LEDs; where each second switch is closed in response to the respective duty cycles of each second PWM waveform;
so that each LED connected between each second switch and a power source is energized when the first switch and the corresponding second switch are closed and not energized when either the first switch or the corresponding second switch is open.

2. The method of claim 1, where the generating of the first PWM waveform is performed by a programmed processor.

3. The method of claim 1, where the generating of the plurality of second PWM waveforms is performed by a programmed processor.

4. A circuit for dimming a plurality of LEDs, the circuit comprising:
a first PWM circuit;
the first PWM circuit having a first duty cycle
a plurality of second PWM circuits;
the plurality of second PWM circuits each having a duty cycle;
the duty cycle of each of the second PWM circuits configured to start at substantially the same time as the start of the duty cycle of the first PWM circuit;
the period of each of the second PWM circuits configured to end at or before the end of the iteration of the first PWM circuit;
a first switch responsive to the duty cycle of the first PWM circuit;
a plurality of second switches, each of the second switches responsive to the duty cycle of one of the plurality of second PWM circuits;
each of the second switches capable of being connected to a LED;
so that each LED so connected between each of the second switches and a power source is energized when the first switch and the corresponding second switch are closed, and is not energized when either the first switch or the corresponding second switch is open.

5. The circuit for dimming a plurality of LEDs of claim 4, where each of the plurality of LEDs has a different color.

6. The circuit for dimming a plurality of LEDs of claim 5, where the plurality of LEDs comprises:
a red LED, a green LED, and a blue LED.

7. The circuit for dimming a plurality of LEDs of claim 4, where the circuit further comprises a programmed processor; the programmed processor having instructions for generating of the first PWM waveform.

8. The circuit for dimming a plurality of LEDs of claim 4, where the circuit further comprises a programmed processor; the programmed processor having instructions for generating the plurality of second PWM waveforms.

9. A circuit for dimming a plurality of LEDs, the circuit comprising:
a means for generating a first PWM waveform;
the first PWM waveform having a first duty cycle
means for generating a plurality of second PWM waveforms;
the plurality of second PWM waveforms each having a duty cycle;
means for starting the duty cycle of the first PWM waveform and the duty cycle of each of the second PWM waveforms at substantially the same time;
means for ending the duty cycles of each of the second PWM waveforms before the end of the first PWM duty cycle;
means for closing and opening a first switch in response to the duty cycle of the first PWM waveform;
means for closing and opening each of a plurality of second switches connected between the first switch and a corresponding plurality of LEDs;
where each second switch is closed in response to the respective duty cycles of each second PWM waveform;
so that each LED connected between each of the second switches and a power source is energized when the first switch and the corresponding second switch are closed, and is not energized when either the first switch or the corresponding second switch is open.

10. The circuit for dimming a plurality of LEDs of claim 9, where each of the plurality of LEDs has a different color.

11. The circuit for dimming a plurality of LEDs of claim 10, where the plurality of LEDs comprises:
a red LED, a green LED, and a blue LED.

12. The circuit for dimming a plurality of LEDs of claim 10, where the means for generating the first PWM waveform comprises a programmed processor; the programmed processor having instructions for generating the first PWM waveform.

13. The circuit for dimming a plurality of LEDs of claim 10, where the means for generating the plurality of second PWM waveforms further comprises a programmed processor; the programmed processor having instructions for generating the plurality of second PWM waveforms.

14. A computer-readable medium having computer-executable instructions for performing a method; the method comprising:
generating a first PWM waveform;
the first PWM waveform having a first duty cycle
generating a plurality of second PWM waveforms;
each of the plurality of second PWM waveforms having a duty cycle;
starting the duty cycle of the first PWM waveform and the duty cycle of each of the second PWM waveforms at substantially the same time;
ending the periods of each of the second PWM waveforms before the end of the first PWM iteration;
causing the closing and opening a first switch in response to the duty cycle of the first PWM waveform;
causing the closing and opening each of a plurality of second switches connected between the first switch and a corresponding plurality of LEDs;
where each second switch is closed in response to the respective duty cycles of each second PWM waveform;
so that each LED connected between each second switch and a power source is energized when the first switch and the corresponding second switch are closed and not energized when either the first switch or the corresponding second switch is open.

15. The computer-readable medium having computer-executable instructions for performing a method of claim 14; the method further comprising generating the first PWM waveform with a programmed processor.

16. The computer-readable medium having computer-executable instructions for performing a method of claim 14; the method further comprising generating the plurality of second PWM waveforms with a programmed processor.

17. A dimmable illumination device, comprising:
a first LED, a second LED, and a third LED, each of the first, second and third LEDs emitting light at a different wavelength than either of the other LEDs;
three color PWM waveform sources, selectable to drive the first, second and third LEDs independent of one another;
an intensity PWM waveform source, coupled to the first, second, and third LED's to drive the first, second, and third LEDs in combination;
where the iteration of the intensity PWM waveform source is an integral multiple of each of the periods of the three color PWM waveform sources.

18. The dimmable illumination device of claim 17, where the first LED is red, the second LED is green, and the third LED is blue.

19. The dimmable illumination device of claim 17, further comprising a programmed processor; the programmed processor having instructions for generating the three color PWM waveforms.

20. The dimmable illumination device of claim 17, further comprising a programmed processor; the programmed processor having instructions for generating the intensity PWM waveform.

21. An instrument panel, the instrument panel comprising:
a plurality of LEDs;
a circuit for dimming the plurality of LEDs, the circuit comprising:
a first PWM circuit;
the first PWM circuit having a first duty cycle
a plurality of second PWM circuits;
the plurality of second PWM circuits each having a duty cycle;
the duty cycle of each of the second PWM circuits configured to start at substantially the same time as the start of the duty cycle of the first PWM circuit;
the period of each of the second PWM circuits configured to end at or before the end of the iteration of the first PWM circuit;
a first switch responsive to the duty cycle of the first PWM circuit;
a plurality of second switches, each of the second switches responsive to the duty cycle of one of the plurality of second PWM circuits;
each of the second switches capable of being connected to a LED;
so that each LED so connected between each of the second switches and a power source is energized when the first switch and the corresponding second switch are closed, and is not energized when either the first switch or the corresponding second switch is open.

22. The instrument panel of claim 21, where each of the plurality of LEDs has a different color.

23. The instrument panel of claim 21, where the plurality of LEDs comprises:
a red LED, a green LED, and a blue LED.

24. The instrument panel of claim 21, where the circuit for generating the first PWM waveform comprises a programmed processor; the programmed processor having instructions for generating the first PWM waveform.

25. The instrument panel of claim 21, where the circuit for generating the plurality of second PWM waveforms further comprises a programmed processor;
the programmed processor having instructions for generating the plurality of second PWM waveforms.

26. An instrument panel, the instrument panel comprising:
a plurality of LED's:
a computer-readable medium having computer-executable instructions for performing a method; the method comprising:
generating a first PWM waveform;
the first PWM waveform having a first duty cycle
generating a plurality of second PWM waveforms;
each of the plurality of second PWM waveforms having a duty cycle;
starting the duty cycle of the first PWM waveform and the duty cycle of each of the second PWM waveforms at substantially the same time;
ending the periods of each of the second PWM waveforms before the end of the first PWM iteration;
causing the closing and opening a first switch in response to the duty cycle of the first PWM waveform;
causing the closing and opening each of a plurality of second switches connected between the first switch and a corresponding plurality of LEDs; where each second switch is closed in response to the respective duty cycles of each second PWM waveform;
so that each LED connected between each second switch and a power source is energized when the first switch and the corresponding second switch are closed and not energized when either the first switch or the corresponding second switch is open.

27. The instrument panel of claim 26, where the generating of the first PWM waveform is performed by a programmed processor.

28. The method of claim 26, where the generating of the plurality of second PWM waveforms is performed by a programmed processor.

29. An area lighting system, the area lighting system comprising:
a plurality of LEDs;
a circuit for dimming the plurality of LEDs, the circuit comprising:
a first PWM circuit;
the first PWM circuit having a first duty cycle
a plurality of second PWM circuits;
the plurality of second PWM circuits each having a duty cycle;
the duty cycle of each of the second PWM circuits configured to start at substantially the same time as the start of the duty cycle of the first PWM circuit;
the period of each of the second PWM circuits configured to end at or before the end of the iteration of the first PWM circuit;
a first switch responsive to the duty cycle of the first PWM circuit;
a plurality of second switches, each of the second switches responsive to the duty cycle of one of the plurality of second PWM circuits;
each of the second switches capable of being connected to a LED;
so that each LED so connected between each of the second switches and a power source is energized when the first switch and the corresponding second switch are closed, and is not energized when either the first switch or the corresponding second switch is open.

30. The area lighting system of claim 29, where each of the plurality of LEDs has a different color.

31. The area lighting system of claim 29, where the plurality of LEDs comprises:
a red LED, a green LED, and a blue LED.

32. The area lighting system of claim 29, where the circuit for generating the first PWM waveform comprises a programmed processor; the programmed processor having instructions for generating the first PWM waveform.

34. The area lighting system of claim 29, where the circuit for generating the plurality of second PWM waveforms further comprises a programmed processor;
the programmed processor having instructions for generating the plurality of second PWM waveforms.

35. An area lighting system, the area lighting system comprising:
a plurality of LED's:
a computer-readable medium having computer-executable instructions for performing a method; the method comprising:
generating a first PWM waveform;
the first PWM waveform having a first duty cycle
generating a plurality of second PWM waveforms;
each of the plurality of second PWM waveforms having a duty cycle;
starting the duty cycle of the first PWM waveform and the duty cycle of each of the second PWM waveforms at substantially the same time;
ending the periods of each of the second PWM waveforms before the end of the first PWM iteration;
causing the closing and opening a first switch in response to the duty cycle of the first PWM waveform;
causing the closing and opening each of a plurality of second switches connected between the first switch and a corresponding plurality of LEDs; where each second switch is closed in response to the respective duty cycles of each second PWM waveform;
so that each LED connected between each second switch and a power source is energized when the first switch and the corresponding second switch are closed and not energized when either the first switch or the corresponding second switch is open.

36. The area lighting system of claim 35, where the generating of the first PWM waveform is performed by a programmed processor.

37. The method of claim 35, where the generating of the plurality of second PWM waveforms is performed by a programmed processor.
